(19) United States
(12) Patent Application Publication
(10) Pub. No.: US 2024/0149792 A1
(43) Pub. Date: May 9, 2024

(54) MOTOR VEHICLE WITH AN ASSISTANCE SYSTEM

(71) Applicant: Brose Fahrzeugteile SE & Co. Kommanditgesellschaft, Bamberg, Bamberg (DE)

(72) Inventors: Thomas Liedtke, Eisenach (DE); Bernd Herthan, Michelau (DE); Bertram Bopp, Bamberg (DE)

(21) Appl. No.: 18/519,331

(22) Filed: Nov. 27, 2023

Related U.S. Application Data
(63) Continuation of application No. PCT/EP2022/063568, filed on May 19, 2022.

(30) Foreign Application Priority Data
May 25, 2021 (DE) 10 2021 205 311.4

(51) Int. Cl. B60R 1/26; B60R 1/06; B60R 1/12; H04N 13/239

(52) U.S. Cl. CPC B60R 1/26; B60R 1/06; B60R 1/12; B60R 2001/1253; B60R 2300/107; B60R 2300/303; B60R 2300/8026; H04N 13/239

(57) ABSTRACT

A motor vehicle has an assistance system which contains an optical sensor which defines an acquisition area. The acquisition area is directed diagonally to a rear with respect to a longitudinal direction of the motor vehicle. The optical sensor has a 3D camera. The area of the acquisition area is displayed on a display in the interior of the vehicle.

The invention relates to a motor vehicle with an assistance system, which has an optical sensor having an acquisition area. Furthermore, the invention relates to a method for operating an assistance system of a motor vehicle and an assistance system and a computer program product.

Passenger vehicles typically have two exterior mirrors, which are attached on the outside to the body in the area of the two front side doors. Each exterior mirror typically has an exterior mirror housing, by means of which a mirror is held at least partially, which delimits the exterior mirror to the rear with respect to the longitudinal direction or is at least visible therefrom. By means of the mirror it is possible for a driver of the motor vehicle to monitor an area lying diagonally behind the motor vehicle in its longitudinal direction. The aerodynamic shape of the exterior mirror is improved in comparison to the essentially flatly arranged mirror by means of the exterior mirror housing. Furthermore, a mechanism for adjusting the mirror is usually also provided inside the exterior mirror housing, so that it can be adjusted to different drivers.

In order that a comparatively large area is presented to the driver by means of the mirror and thus an observation during the journey with a so-called fleeting glance is simplified, the mirror usually has a comparatively large area which is arranged perpendicular to the longitudinal direction of the motor vehicle. It is therefore necessary for the exterior mirror housing to have a certain minimum size.

If only comparatively small amounts of energy are available for the operation of the motor vehicle, in particular if it is designed as an electric vehicle, a travel resistance of the motor vehicle is to be as low as possible, however. For this purpose, on the one hand, a so-called cw value is reduced, which is achieved in the area of the exterior mirror by means of a suitable shape of the exterior mirror housing. However, the travel resistance is additionally influenced by the size of the silhouette of the motor vehicle perpendicular to its direction of movement. Since the comparatively large mirror is accommodated by means of the exterior mirror housing, it is not possible to reduce the silhouette in the area of the exterior mirror.

To reduce the size of the exterior mirror, the mirror is therefore usually not provided and instead an optical sensor is used. This is usually a camera and the images acquired by means of the camera are reproduced in an interior of the motor vehicle by means of a corresponding device. It is possible here that the images reproduced by means of the display have a modified color dynamic. Moreover, it is usually not possible or is only possible with comparatively great effort in this case for the driver to estimate the distance of an object reproduced by means of the images and its possible velocity. As a result, the probability of an accident is increased. Increased concentration is also required for the driver in order to acquire the area lying behind the motor vehicle. Comfort is therefore reduced and the attentiveness of the driver is led away from the area lying in front of the motor vehicle, so that the probability of an accident is also increased because of this.

The invention is based on the object of specifying a particularly suitable motor vehicle having an assistance system and a particularly suitable method for operating an assistance system of a motor vehicle and also a particularly suitable assistance system of a motor vehicle and a particularly suitable computer program product, wherein a level of comfort for a user and/or a level of safety is advantageously increased.

This object is achieved according to the invention with respect to the motor vehicle by the features of claim 1, with respect to the method by the features of claim 4, with respect to the assistance system by the features of claim 9, and with respect to the computer program product by the features of claim 10. Advantageous refinements and embodiments are the subject matter of the respective dependent claims.

The motor vehicle is in particular a land vehicle that is preferably a multitrack vehicle. It is suitably possible in this case to position the motor vehicle essentially freely, in particular on a corresponding roadway. For this purpose, the motor vehicle expediently has corresponding wheels. In summary, it is preferably possible to position the motor vehicle essentially independently of other conditions on land. In other words, the motor vehicle is suitably not rail-guided. The motor vehicle is preferably a passenger vehicle or a utility vehicle, such as a truck or bus.

At least some of the wheels of the motor vehicle are expediently designed as steerable, so that a direction of movement of the motor vehicle can be changed. The motor vehicle has a longitudinal direction. In the intended use, the motor vehicle is moved forward along the longitudinal direction, in particular if no change of the direction of movement takes place. If the wheels have a steering angle, however, the motor vehicle is only partially moved along the longitudinal direction.

The motor vehicle expediently comprises a main drive, by means of which the motor vehicle is driven in the longitudinal direction. The main drive preferably acts on at least some of the wheels of the motor vehicle. The main drive comprises, for example, an internal combustion engine, an electric motor, or a combination thereof. In particular, the main drive is designed such that by means of it a movement of the motor vehicle preferably takes place in the longitudinal direction, thus forward. Moreover, the motor vehicle has a reverse gear, for example, by means of which a movement of the motor vehicle can take place counter to the longitudinal direction, thus to the rear.

In particular, the motor vehicle comprises an interior, within which a user, namely the driver, of the motor vehicle is located if the motor vehicle is moving. The motor vehicle suitably comprises a seat arranged in the interior, which is directed forward in the longitudinal direction and which is provided for the driver. In particular, a steering wheel and/or other operating elements are assigned to this seat, so that a control of the motor vehicle can take place from this seat. A windshield is preferably arranged in front of the seat in the longitudinal direction, so that the user seated on the seat, who is also designated as the operator, can observe through the windshield the area lying in front of the motor vehicle in the longitudinal direction.

The assistance system has an optical sensor having an acquisition area. It is possible in this case to acquire an object in the acquisition area by means of the optical sensor. If the object is, however, not located within the acquisition area, an acquisition by means of the optical sensor is not possible. The acquisition area is directed into the surroundings, thus the environment, of the motor vehicle. In other words, an area lying in the motor vehicle is not or at most is only additionally a component of the acquisition area. The acquisition of the object takes place optically here, thus in particular on the basis of electromagnetic waves, expediently light in the visible range. The optical sensor is suitably passive, so that only incident light is acquired by means of it, but it does not emit any light itself.

The acquisition area is directed diagonally to the rear with respect to the longitudinal direction of the motor vehicle. In other words, at least a part of the area of the surroundings of the motor vehicle lying behind the motor vehicle is a part of the acquisition area. For example, the acquisition area extends to directly behind the motor vehicle in the longitudinal direction. For example, a longitudinal axis of the motor vehicle, which extends parallel to the longitudinal direction and in particular is arranged centrally inside the motor vehicle, extends through the acquisition area. Alternatively, this part is not a component of the acquisition area. In other words, the acquisition area is laterally offset diagonally to the longitudinal axis. However, at least a part of the surroundings located laterally adjacent to the motor vehicle is also a component of the acquisition area, so that an object located there can be acquired by means of the optical sensor.

It is therefore possible by means of the optical sensor to acquire an object laterally offset both in the longitudinal direction behind the motor vehicle and diagonally to the longitudinal direction, thus to the longitudinal axis. The acquisition area is essentially conical here, for example, wherein the optical sensor is arranged at the tip of the cone. For example, an opening angle of the cone is between 90° and 10°, between 70° and 30°, and, for example, between 45° and 50°. The opening angle is preferably less than 60°, 50°, 45°, or 40°. A design of the optical sensor is thus simplified. In particular, an axis of symmetry of the acquisition area encloses an angle with the longitudinal direction of between 10° and 70°, between 50° and 15°, and, for example, between 40° and 30°.

The optical sensor comprises a 3D camera. The optical sensor is expediently formed by means of the 3D camera, so that the optical sensor has no further components. Production costs are therefore reduced. The 3D camera has two objectives, the position and/or alignment of which in relation to one another is fixed or at least adjustable. In particular, the alignment of the objectives in relation to one another encloses an angle, and the objectives are not arranged parallel to one another. The 3D camera preferably comprises one or more image sensors, wherein each of the image sensors is expediently assigned one of the objectives. Alternatively thereto, both objectives are assigned to the same image sensor. The image sensor is, for example, a CCD chip or a CMOS chip. The objectives and the image sensor or the image sensors are suitably arranged in a common housing, so that installation is facilitated. The 3D camera preferably additionally comprises a graphics processor (GPU), by means of which the signals/data created by means of the possible image sensor are processed during operation.

A 3D image is preferably created here by means of the graphics processor on the basis of the signals/data created by means of the image sensor/image sensors.

Due to the 3D camera, the acquisition area is thus acquired three-dimensionally, and the images created by means of the optical sensor are thus three-dimensional images (3D images) and therefore have additional information in comparison to a two-dimensional image. It is therefore possible to display the additional information to the user, such as the distance of the object. The acquisition of the additional information is thus simplified for the user, and so a level of comfort is increased for them. It is not necessary in this case for the user to use a comparatively large part of their attention. The user, in particular the driver, can therefore direct a large part of their attention to further parts of the surroundings of the motor vehicle, in particular the area lying in front of the motor vehicle in the longitudinal direction. In this way, it is possible to avoid a collision of the motor vehicle with an object possibly located in front of the motor vehicle in the longitudinal direction when the motor vehicle is moving forward in the longitudinal direction. The driver is also informed due to the optical sensor about objects which are located diagonally behind the motor vehicle, and which are therefore not directly in the field of view of the driver. A level of safety is thus increased, for example, during a turnoff maneuver of the motor vehicle. Moreover, it is possible to provide the additional information which is acquired by means of the optical sensor to further components of the motor vehicle, in particular further assistance systems. Therefore, accuracy and/or dealing with current requirements/conditions is also improved during their operation, so that a level of safety is also increased.

For example, the optical sensor is arranged in a rear bumper of the motor vehicle in the longitudinal direction, in a C-pillar, or on a rear roof edge in the longitudinal direction and held there, for example, in a corresponding respective receptacle. In this way, it is possible to select a size of the silhouette of the motor vehicle to be comparatively small, so that a travel resistance of the motor vehicle is comparatively small.

Alternatively thereto, the assistance system comprises an exterior mirror housing which is designed as L-shaped or droplet-shaped, for example. The exterior mirror housing is fastened on an outer side of a body of the motor vehicle, for example, on a door of the motor vehicle or a fender. In particular, the exterior mirror housing is fastened on a driver door, a front passenger door, or an A-pillar of the motor vehicle. The exterior mirror housing expediently projects beyond the body.

The optical sensor, or at least the 3D camera, is arranged inside the exterior mirror housing. As a result, it is possible to adjust the acquisition area by means of the exterior mirror housing or a mechanism arranged therein, so that a blind spot is comparatively small. In other words, the optical sensor is offset outward with respect to the body, thus farther away from the longitudinal axis, so that a blind spot is reduced. Due to the small size of the 3D camera, it is possible here to select a size of the exterior mirror housing to be comparatively small so that the silhouette of the motor vehicle is only enlarged comparatively slightly.

In particular, no further mirror is arranged in the exterior mirror housing and, for example, also no other components of the motor vehicle. The assistance system is preferably at least partially a component of an exterior mirror of the motor vehicle, wherein the exterior mirror itself does not comprise a mirror. The exterior mirror is therefore mirror-free and the function of the mirror is at least partially fulfilled by means of the optical sensor. A size of the exterior mirror housing is thus further reduced.

The motor vehicle particularly preferably comprises two such exterior mirror housings/exterior mirrors, wherein they are located on different longitudinal sides of the motor vehicle, thus on opposite sides with respect to the longitudinal axis of the motor vehicle extending along the longitudinal direction. A corresponding 3D camera is preferably arranged in this case in each exterior mirror housing, so that the motor vehicle has two 3D cameras. The provided information is therefore comparatively extensive and the acquisition area provided by means of the two 3D cameras is comparatively large.

Alternatively thereto, a monocamera is arranged in each of the two exterior mirror housings, each of which is a component of the 3D camera. In other words, an objective of the 3D camera is arranged in each of the exterior mirror housings and the objectives are arranged such that their respective monitoring area partially overlaps with the acquisition area of the 3D camera. The acquisition area of the 3D camera is reduced in this way, but production costs are reduced.

A display of the assistance system is preferably arranged in the interior of the motor vehicle, which is signally connected to the optical sensor. A line is provided for this purpose, for example, or the display and the 3D cameras are connected to one another via a bus system of the motor vehicle. For example, the display and the 3D camera are directly signally connected to one another or via further components of the motor vehicle, preferably of the assistance system. It is therefore possible to output the images created by means of the optical sensor by means of the display and thus present them to the user. A representation of the object is preferably output here by means of the display, which object is acquired by means of the 3D camera in the acquisition area.

Since the display is located in the interior of the motor vehicle, it is protected from environmental influences, and so operational reliability is increased. It is therefore not necessary to design the display as comparatively robust, so that production costs are reduced. It is also possible to arrange the display in a field of view of the driver, or at least directly adjacent thereto, when they look forward in the longitudinal direction, so that excessive turning of the head is not required for the driver. A level of comfort is therefore increased.

The display is, for example, a flat display or comprises a projector, by means of which a projection into an eye of the driver or another user takes place during operation. In particular, the display is 3D capable, so that the images created by means of the 3D camera can be reproduced as a three-dimensional image by means of the display. The display is preferably based on laser technology or is an autostereoscopic display. Due to the three-dimensional representation by means of the display, an estimation of a distance of the representation of the object displayed by means of the 3D image or other image to the motor vehicle is simplified for the user, in particular the driver, so that a level of comfort is further simplified. An incorrect estimation by the driver is also avoided in this way, and so a level of safety is increased.

The method is used for the operation of an assistance system of a motor vehicle. In other words, the assistance system is in the intended state a component of the motor vehicle and is suitable, in particular provided and configured, for this purpose. The assistance system comprises an optical sensor, which has an acquisition area. The acquisition area is directed diagonally to the rear with respect to a longitudinal direction of the motor vehicle and the optical sensor comprises a 3D camera. Moreover, the assistance system comprises a display, which is arranged in an interior of the motor vehicle. The optical sensor and/or the display are suitable, in particular provided and configured, for the respective use. For example, they each have corresponding fasteners or other provisions for this purpose. In particular, the method is thus also used for the operation of a motor vehicle in which a corresponding assistance system is installed.

The method provides that a 3D image of the acquisition area is created by means of the optical sensor. The 3D image is expediently created by means of the 3D camera. The 3D image is output by means of the display, thus in the interior of the motor vehicle. A graphics processor is preferably used to create the 3D image, so that a period of time for creating the 3D image on the basis of signals/data provided by means of any image sensor of the optical sensor is comparatively short. For example, the 3D image directly acquired by means of the optical sensor is output. Alternatively thereto, the 3D image is postprocessed, and in particular a magnification factor is adjusted. This is dependent, for example, on a current status of the motor vehicle, a user setting, and/or environmental conditions, for example, a brightness or weather. In this way, a presentation of the information contained in the 3D image is improved for the user.

The 3D image is particularly preferably output during a movement of the motor vehicle in the longitudinal direction at least partially forward. In other words, if the motor vehicle is in the longitudinal direction directly forward or at least partially in the longitudinal direction forward, since a steering angle of the possible steerable wheels is present, the 3D image is output. In this way, the area located diagonally behind the motor vehicle is at least partially visible via the display to the driver of the motor vehicle, so that a level of safety is increased. In other words, the assistance system acts like an exterior mirror and the motor vehicle expediently does not have an exterior mirror having a mirror, thus a reflective surface for the purpose of imaging the area located diagonally behind the motor vehicle in the longitudinal direction.

The 3D image is expediently created again essentially continuously in this case by means of the optical sensor, preferably the 3D camera. The respective newly created 3D image is output here by means of the display, preferably until a newer version of the 3D image is present which is then output. An essentially continuous operation of the display is therefore visible to the user, and so no fatigue takes place. The user is thus also informed about a change of the surroundings in the acquisition area, for example, about a change of the position of the possible object.

For example, the 3D image is always output during a movement of the motor vehicle in the longitudinal direction at least partially forward, or only when the motor vehicle has at least a certain speed, preferably 5 km/h, 10 km/h, or 20 km/h. However, the 3D image is at least also output by means of the display during a movement of the motor vehicle in the longitudinal direction at a speed above 5 km/h, 10 km/h, or 20 km/h.

For example, if the motor vehicle is moved counter to the longitudinal direction, the 3D image is not output or particularly preferably is also in this case. Alternatively thereto, if the motor vehicle is not moving, thus in particular is stationary, the 3D image is not output. However, the 3D image is particularly preferably also output in this case at least as long as the motor vehicle is ready for operation. If the motor vehicle is stopped and, for example, an ignition is switched off, or the motor vehicle is parked in another way, the output of the 3D image is preferably ended. An energy consumption is thus reduced.

Alternatively or particularly preferably in combination therewith, the acquisition area is monitored by means of the optical sensor for a user carrying out a gesture when the motor vehicle is at a standstill. In other words, if the motor vehicle is parked in particular, it is monitored by means of the sensor whether the user carries out a gesture in the acquisition area. The gesture is, for example, a movement of a hand and/or arm of the user or a foot/leg of the user or a combination thereof. The monitoring takes place continuously, for example, if the motor vehicle was stopped/parked, or when a certain condition is met. The condition is expediently met here when a presence of the user was acquired, in particular by means of a corresponding sensor. By means of this, for example, an object carried by the user, such as a radio key or a smartphone/wearable, is acquired. In other words, the presence of the object carried by the user is concluded by means of the sensor on the basis of a radio connection and the presence of the user is concluded on the basis thereof.

When the gesture carried out by the user corresponds to a stored pattern, a vehicle function is carried out. The stored pattern is in particular stored in a memory and, for example, is specified by the producer and/or changeable by the user. For example, it is necessary for the correspondence for the gesture to correspond exactly with the stored pattern, or at least in the range of certain, expediently stored tolerances. The 3D image is preferably not output on the display when the vehicle is at a standstill, so that an energy consumption is. The gesture is preferably acquired by means of the 3D camera, so that this comparatively accurate acquisition is enabled. Distinguishing the desired gesture from another movement of the user is thus simplified, and inadvertently carrying out the vehicle function is avoided.

For example, actuating an electromotive adjustment drive is used as the vehicle function. The electromotive adjustment drive is expediently a component of the assistance system. Alternatively, the vehicle function is causing a corresponding actuation, in particular if the electromotive adjustment drive is not a component of the assistance system. The electromotive adjustment drive comprises an electric motor by means of which an adjustment part is driven along an adjustment path, in particular via further components such as a gearing and/or a spindle. For example, the electromotive adjustment drive is an electromotive seat adjuster, an electrically actuated lock, or an electromotive door adjuster, wherein the door forms the adjustment part and is, for example, a side door of the motor vehicle or a rear hatch.

An object is particularly preferably acquired by means of the optical sensor in operation when this object is located in the acquisition area, expediently by means of the 3D camera. The object located in the acquisition area is therefore acquired by means of the optical sensor. In particular a classification and/or analysis of the 3D image created by means of the 3D camera is performed, preferably by means of the possible graphics processor. A value characterizing the object is additionally displayed on the display. In other words, the value characterizing the object is initially ascertained and additionally presented to the user on the display. For example, for this purpose only the characterizing value is displayed on the display or expediently is displayed in addition to a representation of the object. For example, the characterizing value is displayed separately from the representation of the object or particularly preferably the displayed characterizing value is overlaid with the representation of the object, so that a context is comparatively easily obvious to the user. The characterizing value is, for example, a text field or a symbol.

For example, a distance of the object to the motor vehicle is used as a characterizing value. In particular, the distance is output in this case by means of a text field, for example, in metric data. As a result, it is directly obvious to the user how far away the object is located from the motor vehicle, independently of a current magnification factor of the 3D image. A level of safety is thus increased. Alternatively or in combination thereto, a speed of the object is used as a characterizing value, wherein the speed of the object is specified, for example, absolutely or relative to a movement speed of the motor vehicle. In this way, an approach taking place to the object is derivable comparatively easily for the user.

A hazard potential is particularly preferably used as a characterizing value. The hazard potential relates in particular to the object or the motor vehicle or both. For example, the probability of an accident is used as the hazard potential. For example, the output hazard potential has discrete steps, for example three, wherein at one of the steps no hazard potential is present, at a further step a moderate hazard potential prevails, and at the third step a comparatively high hazard potential is present, in the case of which in particular upon unchanged movement of the motor vehicle a collision with the object is to be expected within a time span which is, for example, less than 30 seconds, 20 seconds, or 10 seconds. In particular, the hazard potential is determined on the basis of further parameters/information, in particular a vehicle status of the motor vehicle.

For example, the representation of the object is adapted to indicate the hazard potential or other characterizing value and, for example, a color overlay is created for this purpose. Alternatively thereto, a part of the representation of the object is colored with a specific color or a border thereof is shown in color. It can therefore be judged by a user within a comparatively short time span whether the object acquired by means of the 3D camera has the hazard potential, thus whether, for example, a collision with it is probable.

The assistance system, at least in the installed state, is a component of a motor vehicle, which is in particular a land vehicle. The motor vehicle is, for example, a truck, bus, or preferably a passenger vehicle. The assistance system comprises an optical sensor which has an acquisition area. In the installed state, the acquisition area is directed diagonally to the rear with respect to a longitudinal direction of the motor vehicle. The sensor is suitable, in particular provided and configured, for this purpose. For example, the sensor comprises a corresponding installation means for suitable attachment to further components of the motor vehicle. A setting/orientation of the acquisition area is expediently carried out thereby. The optical sensor comprises a 3D camera and is expediently formed by means of it. The 3D camera comprises at least two objectives, the position and/or orientation of which is suitably fixed. In particular, the 3D camera comprises an image sensor, such as a CCD chip or CMOS chip, suitably two thereof, wherein one objective is assigned to each image sensor.

In one refinement, the assistance system comprises a display, which is expediently arranged in an interior of the motor vehicle in the installed state. The display is suitable, in particular provided and configured, for this purpose. The display is preferably 3D capable. The assistance system is expediently operated according to a method in which a 3D image of the acquisition area is created by means of the optical sensor and is output by means of the display.

The assistance system has in particular a control unit which is suitable, in particular provided and configured, to carry out the method. The control unit comprises, for example, an application-specific integrated circuit (ASIC) or particularly preferably a computer, which is suitably designed as programmable. In particular, the control unit comprises a storage medium, on which a computer program product, which is also referred to as a computer program, is stored, wherein upon execution of this computer program product, thus of the program, the computer is prompted to carry out the method. Further tasks are preferably assumed by means of the control unit.

The computer program product comprises a number of commands which, upon the execution of the program (computer program product) by a computer, prompt it to carry out a method for operating an assistance system of a motor vehicle. The assistance system comprises an optical sensor which has an acquisition area which is directed diagonally to the rear with respect to a longitudinal direction of the motor vehicle, wherein optical sensor comprises a 3D camera. A display of the assistance system is arranged in an interior of the motor vehicle, which is signally connected to the optical sensor. In the method, a 3D image of the acquisition area is created by means of the optical sensor and output by means of the display.

The computer is expediently a component of a control unit or electronics unit and, for example, is formed thereby. The computer preferably comprises a microprocessor or is formed by means of it. The computer program product is, for example, a file or a data carrier which contains an executable program which automatically carries out the method upon installation on a computer.

The invention furthermore relates to a storage medium on which the computer program product is stored. Such a storage medium is, for example, a CD-ROM, a DVD, or a Blu-ray disc. Alternatively thereto, the storage medium is a USB stick or another memory which is rewritable or is only writable once, for example. Such a memory is, for example, a flash memory, a RAM, or a ROM.

Moreover, the invention relates to a control unit for carrying out the method which is thus suitable, in particular provided and configured, for this purpose. For this purpose, the control unit has, for example, an application-specific integrated circuit (ASIC) or, for example, a programmable microprocessor, which in particular functions as a computer. The control unit suitably comprises a storage medium, on which the above-described computer program is stored. Furthermore, the invention relates to a motor vehicle having the assistance system. The motor vehicle is operated according to the method. For example, the motor vehicle, preferably the assistance system, comprises a control unit for this purpose, which comprises, for example, the computer program product.

The invention furthermore relates to the use of a 3D camera as an optical sensor, by means of which an area directed diagonally to the rear with respect to a longitudinal direction of a motor vehicle is acquired. The use expediently takes place in this case during a movement of the motor vehicle in the longitudinal direction. In other words, the 3D camera is expediently used as an exterior mirror or at least part of an exterior mirror.

The refinements and advantages explained in conjunction with the motor vehicle can also be applied mutatis mutandis to the method/the assistance system/the computer program product/the storage medium/the control unit/the motor vehicle/the use and among one another and vice versa.

An exemplary embodiment of the invention is explained in more detail hereinafter on the basis of a drawing. In the figures:

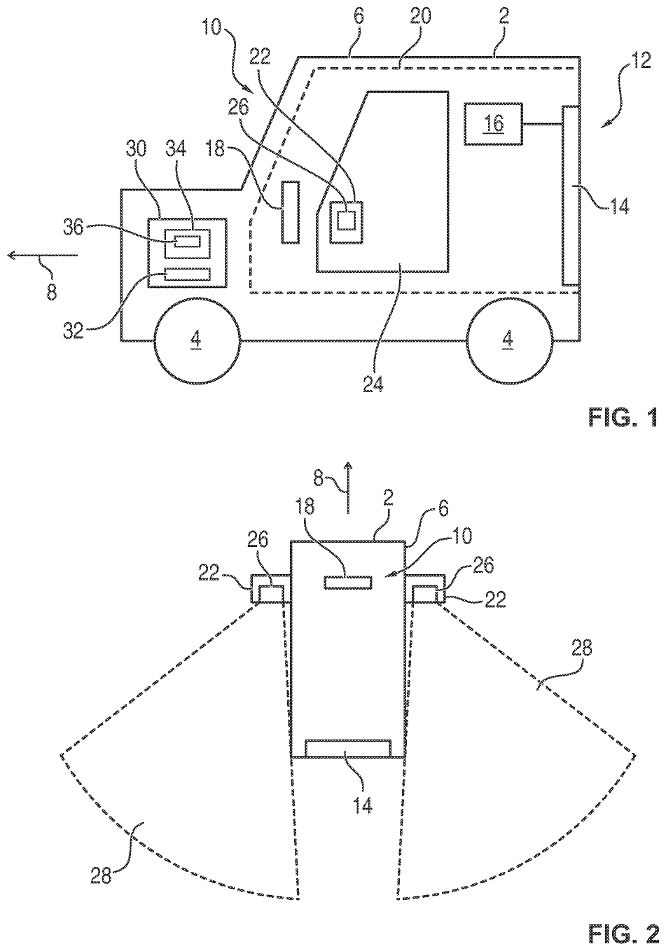

FIG. 1 schematically shows a side view of a motor vehicle having an assistance system, which comprises a sensor and a display,

FIG. 2 schematically shows a top view of the motor vehicle,

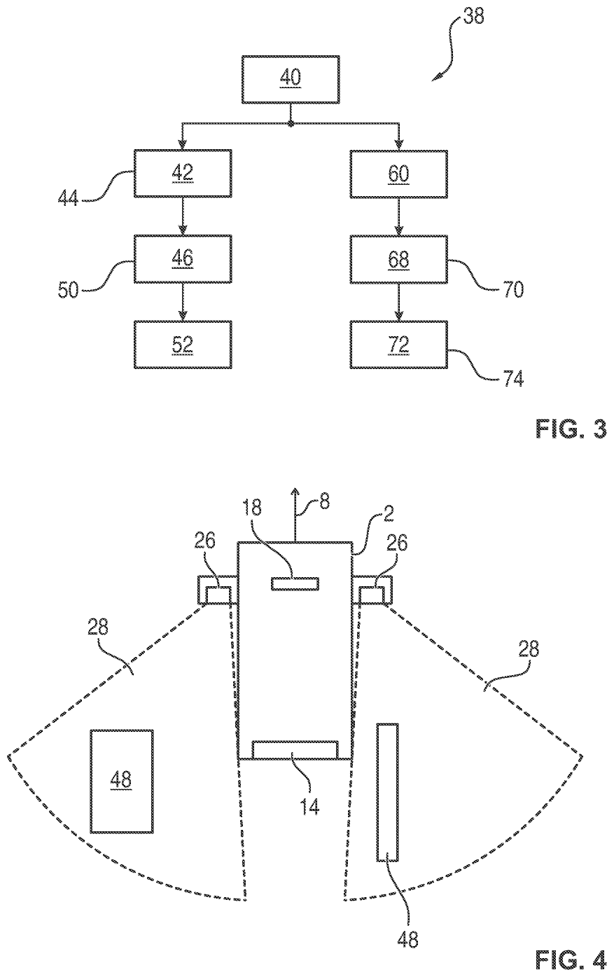

FIG. 3 shows a method for operating the assistance system,

FIG. 4 shows the motor vehicle according to FIG. 2 during a part of the method,

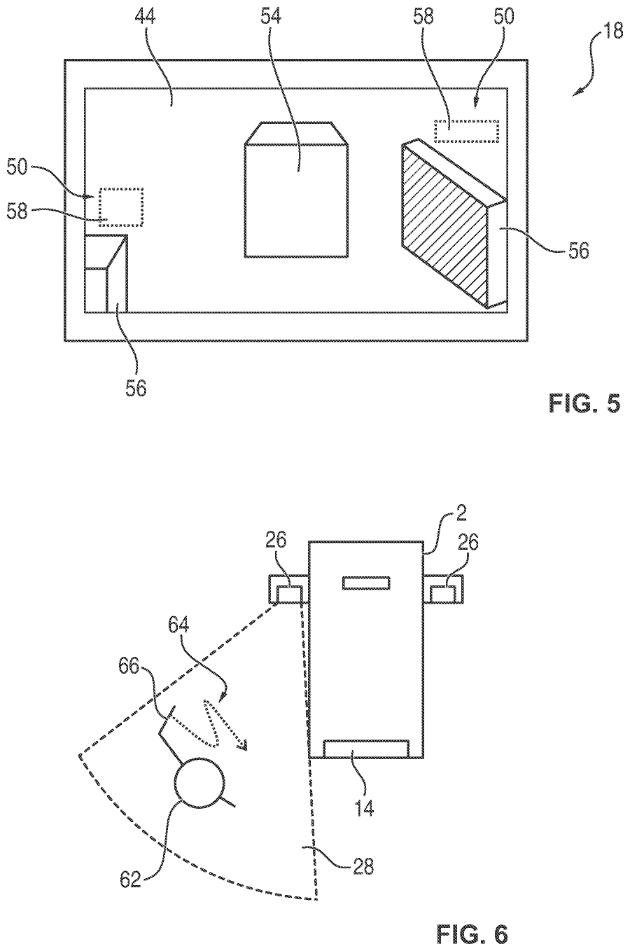

FIG. 5 schematically shows the display at the first point in time, and

FIG. 6 shows the motor vehicle according to FIG. 2 during another part of the method.

Parts corresponding to one another are provided with the same reference signs in all figures.

A motor vehicle 2 in the form of a passenger vehicle is shown schematically simplified in a side view in FIG. 1 and in a top view in FIG. 2. The motor vehicle has four wheels 4, by means of which a contact takes place to a roadway (not shown in more detail). The wheels 4 are connected via a chassis (not shown) to a body 6 of the motor vehicle, and a part of the wheels 4 is driven by means of a main drive (not shown). At least two of the wheels 4 are also designed as steerable and are a component of a steering system, so that a movement direction of the motor vehicle 2 can be adjusted. If the wheels 4 do not have a steering angle here, the motor vehicle 2 is moved in a longitudinal direction 8.

The motor vehicle 2 comprises an assistance system 10 having an electromotive adjustment drive 12 in the form of an electromotive door adjuster. The electromotive adjustment drive 12 has an adjustment part 14, namely a door, which is mounted by means of a hinge so that it is pivotably movable on further components of the body 6. The door forms a component of the body 6 and is a rear hatch. The electromotive door adjuster is therefore an electromotive (electric motor-operated) rear hatch. The electromotive adjustment drive 12 comprises an electric motor 16, which has an operational connection to the adjustment part 14, thus the door, via a gearing (not shown in more detail) and a spindle. Upon energizing of the electric motor 16, the adjustment part 14 is moved along an adjustment path, which is at least partially curved due to the hinge. In other words, the door is pivoted with respect to the body 6 in this case. The door is opened or closed here depending on the rotational direction of the electric motor 16.

The assistance system 10 furthermore comprises a display 18 which is 3D capable and is arranged in an interior 20 of the motor vehicle 2, which is surrounded by means of the body 6. An opening of the interior 10 is closed here by means of the adjustment part 14, at least as long as the door acting as the adjustment part 14 is closed.

The assistance system 10 has two exterior mirror housings 22, which are each fastened on the outer side of a side door 24 of the body 6. Therefore, two side doors 24 are provided, namely a driver door and a front passenger door. The exterior mirror housings 22 are produced from a plastic and are painted in the vehicle color and designed as droplet-shaped, wherein the openings are each open counter to the longitudinal direction 8, thus in the longitudinal direction to the rear.

An optical sensor 26, which is formed by means of a 3D camera, is arranged in each case inside each exterior mirror housing 22. The two optical sensors 26 are signally connected to the display 18 via a bus system (not shown in more detail). Each 3D camera has two objectives spaced apart from one another, which are directed into a respective acquisition area 28. By means of the objectives, the respective acquisition area 28 is imaged on a respective assigned image sensor of the 3D camera, and the signals/data provided by means of the image sensors are processed by means of a graphics processor (not shown in more detail) of the 3D camera.

The acquisition areas 28 are each defined by means of the alignment of the two objectives of the respective 3D camera and are conical, wherein the respective optical sensor 26 is arranged at the tip of the respective cone. The axis of symmetry of each cone forms an angle of 30° in each case with the longitudinal direction 8, and the opening angle of each cone is 45°. The two acquisition areas 28 are located on opposite longitudinal sides of the motor vehicle 2 and are each aligned directed diagonally to the rear with respect to the longitudinal direction 8 of the motor vehicle 2. In other words, a part of the surroundings of the motor vehicle 2 lying behind the motor vehicle 2 and a part of the surroundings of the motor vehicle 2 lying laterally adjacent to the motor vehicle 2 form the respective acquisition area 28, wherein the two acquisition areas 28 do not overlap or only overlap at a comparatively large distance to the motor vehicle 2.

The assistance system 10 furthermore comprises a control unit 30, which comprises a computer 32 in the form of a programmable microprocessor, or the computer 32 comprises at least the programmable microprocessor. Moreover, the control unit 30 comprises a storage medium 34 in the form of a memory, on which a computer program product 36 is stored. The computer program product 36 comprises commands which, upon the execution of the program by the computer 32, prompt it to carry out a method 38 shown in FIG. 3 for operating the assistance system 10. In other words, the assistance system 10 and therefore also the motor vehicle 2 is operated according to the method 38.

The method 38 is started in a first work step 40. When the motor vehicle 2 is ready for operation, and in particular an ignition is actuated, thus a driver is located in the motor vehicle 2, and the motor vehicle 2 is either moving or is at least ready to move, a second work step 42 is then carried out. The second work step 42 is therefore also carried out when the motor vehicle 2 is at least partially moved forward in the longitudinal direction 8, thus when its speed is greater than 10 km/h.

In the second work step 42, a 3D image 44 is created in each case by means of the two optical sensors 26, namely by means of the respective 3D camera, for which the signals/data provided by means of the respective image sensors are processed by means of the respective graphics processor. Due to the two objectives, each 3D image 44 has additional information in comparison to a two-dimensional image which is only created by means of a single objective.

In a subsequent third work step 46, all objects 48 located in the acquisition areas 28 are identified. In the situation shown in FIG. 4 corresponding to the illustration of FIG. 2, for example, such an object 48 is located in each of the two acquisition areas 28. The object 48 located in the left acquisition area 28 is a further motor vehicle which is overtaking the motor vehicle 2 on a lane (not shown in more detail). The left acquisition area 28 is assigned to the left sensor 26 with respect to the longitudinal axis of the motor vehicle 2, which is fastened on the driver door as the side door 24. The object 48 located in the right acquisition area 28 is a bicyclist, who wishes to overtake the motor vehicle 2 on the right side.

Moreover, in the third work step 46, a value 50 characterizing the respective object 48 is created. The characterizing value 50 comprises the distance of the respective object 48 to the motor vehicle, the speed of the respective object 48 relative to the speed of the motor vehicle 2, and a hazard potential. Additional information is taken into consideration in the assessment of the hazard potential, namely the current status of the motor vehicle 2. In this case, the steering angle of the wheels designed as steerable is additionally taken into consideration, wherein in the illustrated example the motor vehicle 2 is to be moved to the right due to the steering angle, wherein a turning off maneuver is to be carried out. As a result, a hazard potential of the left object 48 is essentially not present or is minor, and a collision with it is excluded. In contrast, in the event of unobstructed movement of the motor vehicle 2, a collision with the right object 48, thus the bicyclist, would be probable. In summary, the objects 48 located in the acquisition area 28 are acquired by means of the respective optical sensor 26 and the value 50 characterizing the respective object 48 is created.

In a subsequent fourth work step 52, the created 3D images 44 and the characterizing values 50 are displayed on the display 18, as shown in FIG. 5. The 3D images 44 created by means of the optical sensors 26 are read out for this purpose via the signal connection by means of the display 18. In addition, a representation 54 of the motor vehicle 2 is shown essentially in the center on the display 18, and also the representations 56 of the two objects 48 contained in the 3D images 44. The displayed distance of the representations 56 of the two objects 48 in each case to the representation 54 of the motor vehicle 2 corresponds here to the respective distance of the respective object 48 to the motor vehicle 2. The 3D images 44 of the acquisition area 28 created by means of the optical sensors 26 are therefore output by means of the display 18.

Moreover, the characterizing value 50 of each object 48 is additionally indicated on the display 18. The characterizing value 50 has a text field 58 in each case here, by means of which the distance and the speed of the respective object 48 is indicated. In addition, in the representation 56 of the right object 48, a part is colored red due to the prevailing hazard potential so that the driver of the motor vehicle 2 is notified of the possible collision with this object 48. In summary, the optical sensors 26 in cooperation with the display 18 therefore act as the exterior mirrors of the motor vehicle 2 and are used for this purpose.

In contrast, if the motor vehicle is stationary, a fifth work step 60 is carried out after the first work step 40. The fifth work step 60 is only carried out in this case if a user 62 has been acquired in the surroundings of the motor vehicle 2 by means of a sensor (not shown in more detail), which is shown in FIG. 6 corresponding to the illustration of FIG. 2. The presence of the user 62 is determined here on the basis of a radio key carried by the user 62, which was acquired by means of a radio device (not shown) as the sensor. When this has taken place, the optical sensor 26 facing toward the user 62, thus this 3D camera, is activated. The assigned acquisition area 28 is monitored for the user 62 carrying out a gesture 64 by means of the 3D camera. The user 62 carries out the gesture 64 in this case by means of one hand 66, so that the gesture 64 is a hand gesture. In summary, in the fifth work step 60, the respective acquisition area 28 is monitored for the user 62 carrying out the gesture 64 by means of the respective optical sensor 26.

In a subsequent sixth work step 68, the acquired gesture 64 is compared to a pattern 70 stored in the storage medium 34. If the gesture 64 corresponds with the stored pattern 70 in the scope of inaccuracies, a vehicle function 74 is carried out in a subsequent seventh work step 72. The vehicle function 74 is actuation of the electromotive adjustment drive 12, for which purpose the electric motor 16 is energized. As a result, the adjustment part 14, thus the door, is opened, so that the user 62 can place objects in the interior 20 or remove them therefrom.

The invention is not restricted to the above-described exemplary embodiment. Rather, other variants of the invention can also be derived therefrom by a person skilled in the art without leaving the subject matter of the invention. In particular, furthermore all individual features described in conjunction with the exemplary embodiment can also be combined with one another in other ways without leaving the subject matter of the invention.

List of reference signs

| | |
|---|---|
| 2 | motor vehicle |
| 4 | wheel |
| 6 | body |
| 8 | longitudinal direction |
| 10 | assistance system |
| 12 | electromotive adjustment drive |
| 14 | adjustment part |
| 16 | electric motor |
| 18 | display |
| 20 | interior |
| 22 | exterior mirror housing |
| 24 | side door |
| 26 | optical sensor |
| 28 | acquisition area |
| 30 | control unit |
| 32 | computer |
| 34 | storage medium |
| 36 | computer program product |
| 38 | method |
| 40 | first work step |
| 42 | second work step |
| 44 | 3D image |
| 46 | third work step |
| 48 | object |
| 50 | characterizing value |
| 52 | fourth work step |
| 54 | representation of the motor vehicle |
| 56 | representation of the object |
| 50 | text field |
| 60 | fifth work step |
| 62 | user |
| 64 | gesture |
| 66 | hand |
| 68 | sixth work step |
| 70 | pattern |
| 72 | seventh work step |
| 74 | vehicle functi |

1-10. (canceled)

11. A motor vehicle, comprising:
an assistance system containing an optical sensor defining an acquisition area, the acquisition area being directed diagonally to a rear with respect to a longitudinal direction of the motor vehicle, wherein said optical sensor has a 3D camera.

12. The motor vehicle according to claim 11,
further comprising a body; and
wherein said assistance system further has an exterior mirror housing, said optical sensor is disposed in said exterior mirror housing, said exterior mirror housing is fastened on an outer side of said body.

13. The motor vehicle according to claim 11, wherein said assistance system has a display disposed in an interior of said motor vehicle, wherein said display is signally connected to said optical sensor.

14. A method for operating an assistance system of a motor vehicle, the assistance system having an optical sensor defining an acquisition area, the acquisition area being directed diagonally to a rear with respect to a longitudinal direction of the motor vehicle, wherein the optical sensor has a 3D camera, the method comprises the steps of:
creating a 3D image of the acquisition area by means of the optical sensor; and
outputting the 3D image by means of a display.

15. The method according to claim 14, which further comprises outputting the 3D image during a movement of the motor vehicle in the longitudinal direction at least partially forward.

16. The method according to claim 14, which further comprises:
monitoring the acquisition area by means of the optical sensor for a user carrying out a gesture when the motor vehicle is at a standstill; and
carrying out a vehicle function when the gesture corresponds to a stored pattern.

17. The method according to claim 14, which further comprises:
acquiring an object located in the acquisition area by means of the optical sensor; and
displaying a characterizing value characterizing the object on a display.

18. The method according to claim 17, which further comprises using a distance of the object to the motor vehicle, a speed of the object, and/or a hazard potential as the characterizing value.

19. An assistance system for a motor vehicle, the assistance system comprising:
an optical sensor defining has an acquisition area which is directed diagonally to a rear with respect to a longitudinal direction of the motor vehicle, wherein said optical sensor has a 3D camera; and
the assistance system being programmed to:
create a 3D image of the acquisition area by means of the optical sensor; and
outputting the 3D image by means of a display.

20. A non-transitory computer readable medium having computer executable instructions, which, upon execution of the computer executable instructions on a computer, prompt the computer to carry out the method according to claim 4.
